(19) United States
(12) Patent Application Publication
(10) Pub. No.: US 2025/0289686 A1
(43) Pub. Date: Sep. 18, 2025

(54) SELF-CALIBRATION ELEVATOR DOOR LOCK CONTACT MAKING DEVICE

(71) Applicant: CHINA JILIANG UNIVERSITY, Hangzhou (CN)

(72) Inventors: Qibing Wang, Hangzhou (CN); Jiawei Lu, Hangzhou (CN); Gang Xiao, Hangzhou (CN); Yuejiang Gu, Hangzhou (CN); Jin Qian, Hangzhou (CN); Haibo Shao, Hangzhou (CN); Chen Li, Hangzhou (CN)

(21) Appl. No.: 18/747,289

(22) Filed: Jun. 18, 2024

(30) Foreign Application Priority Data
Mar. 13, 2024 (CN) 202410284149.0

(51) Int. Cl. B66B 13/22

(52) U.S. Cl. CPC B66B 13/22

(57) ABSTRACT

The present application discloses a self-calibration elevator door lock contact making device, which comprises a stationary base plate, a movable base plate, contacts, adjusting components and a controller, wherein the stationary base plate and the movable base plate are oppositely arranged and are respectively provided with contacts, and the two contacts can move relatively laterally or longitudinally through the adjusting components respectively; and the controller is electrically connected with two groups of adjusting components and provided with a contact detection loop capable of monitoring the contact state of the two contacts. The automatic real-time monitoring and automatic calibration of the door lock can be realized, and the door lock can be locked smoothly when the landing door and the car door are closed, thereby reducing the delay caused by inaccurate door operation and the cost of manual maintenance and adjustment, and improving the safety and reliability of the elevator.

### CROSS-REFERENCE TO RELATED APPLICATIONS

This application claims priority of Chinese Patent Application No. 20241028149. 0, filed on Mar. 13, 2024, the entire contents of which are incorporated herein by reference.

### TECHNICAL FIELD

The present application relates to the technical field of elevators, in particular to the technical field of self-calibration elevator door lock contact making devices.

### BACKGROUND

Elevator is a kind of mechanical equipment that vertically lifts between different floors of a building to transport people or goods. An elevator door usually includes a car door (installed on the elevator car moving through the hoistway of the building) and several landing doors (landing doors are installed at the openings leading to the hoistway on each floor of the building). The elevator door lock contact making device is an electrical safety device for detecting whether the landing door and the car door are reliably closed and locked, and has safety contacts connected to the electrical safety loop, for example an elevator door lock switch and elevator door lock device thereof disclosed in the application patent with a publication number of CN113277406A, a roller elevator door lock and elevator door lock component disclosed in the utility model patent with a publication number of CN216471689U and an elevator door lock disclosed in the utility model patent with a publication number of CN203682842U. When the car door or the landing door of the designated floor is not closed, the safety contacts are separated, and the whole door lock loop is in a disconnected state, so that the elevator cannot run; when the car door and the landing door of the designated floor are both closed in good condition, the safety contacts are in contact, and the whole door lock loop is in the on state, so that the elevator can run safely.

However, after long-term use, the position deviation between each group of safety contacts is likely to occur due to wear or other factors, which leads to inaccurate alignment. Therefore, maintenance personnel need to regularly check and adjust the installation positions of each group of safety contacts of the door lock, so as to ensure the normal operation of the car door and the doors at all levels. However, this method is not only labor-intensive, but also unable to adjust the position of each group of safety contacts in time, which needs to be solved urgently.

### SUMMARY

The present application aims to solve the problems in the prior art, and provides a self-calibration elevator door lock contact making device, which can realize independent real-time monitoring and automatic calibration of the door lock and ensure that the door lock can be locked smoothly when the landing door and the car door are closed.

In order to achieve the above object, the present application provides a self-calibration elevator door lock contact making device, which includes a stationary base plate, a movable base plate, contacts, adjusting components and a controller, wherein the stationary base plate and the movable base plate are oppositely arranged and are respectively provided with the contacts, and the two contacts are capable of moving relatively laterally or longitudinally through the adjusting components respectively; the controller is electrically connected with two groups of adjusting components and provided with a contact detection loop capable of monitoring a contact state of the two contacts.

Preferably, the self-calibration elevator door lock contact making device further includes a base plate motor, and the movable base plate is driven by the base plate motor to rotate relative to the stationary base plate.

Preferably, a counterweight is also installed on the movable base plate; the counterweight and the contact located on the movable base plate are respectively arranged on opposite sides of the movable base plate, and the counterweight is capable of moving transversely or longitudinally on the movable base plate through the adjusting components.

Preferably, the adjusting component includes a sliding block, a sliding strip, a strip movability mechanism and a block movability mechanism; the counterweight and the two contacts are respectively installed on three sliding strips, and the three sliding strips are respectively connected with the three sliding blocks in a sliding manner, wherein one of the sliding blocks is connected to a stationary chute of the stationary base plate in a sliding manner; the counterweight and the other sliding block are respectively connected to two movable chutes located on the movable base plate in a sliding manner; the three sliding blocks respectively drive the corresponding sliding strips to vertically slide through the strip movability mechanism; the stationary base plate drives one of the sliding blocks to slide horizontally along the stationary chute through the block movability mechanism, and the movable base plate drives the remaining two sliding blocks to slide horizontally along the movable chute through the block movability mechanism respectively.

Preferably, the strip movability mechanism includes an adjusting part and a positioning part, and the adjusting part includes an adjusting motor, a driving roller and a driven roller; the driving roller and the driven roller are rotatably connected in the sliding blocks respectively, and the axial surfaces thereof can contact with the upper surface and the lower surface of the sliding block; one end of the driving roller is connected with an output shaft of the adjusting motor; the positioning part is composed of grippers respectively arranged on the left and right sides of the sliding strip; the gripper comprises a base shell, a push plate, a push rod, a piston, a spring, an electromagnet and a permanent magnet, wherein one end of the push rod is provided with the push plate, and the other end of the push rod is connected with the piston after extending into the base shell; two ends of the spring are respectively connected with the base shell and the piston, the electromagnet and the permanent magnet are respectively installed in the base shell and the piston, and the push plate is arranged towards the left or right side of the sliding block.

Preferably, the block movability mechanism includes a movability motor, a screw nut, a screw rod, a sliding seat and a sliding rail; both the movability motor and the sliding rail are fixed on the stationary base plate or the movable base plate; the screw nut is rotatably connected in the movability motor, the lead screw penetrates through the movability motor and is in threaded connection with the screw nut; the sliding seat is connected with the lead screw and is simultaneously connected with the sliding rail in a sliding manner; and the lead screw or the sliding seat is connected with the corresponding slide block.

Preferably, the controller is further provided with a short-connection/bridge-connection command transmitter which can send a door lock short-connection/bridge-connection command and a short-connection/bridge-connection circuit for realizing the door lock short-connection/bridge-connection.

Preferably, the controller is further provided with a calibration information receiver which can receive the calibration information of the two contacts (5) in real time and a judgment logic module which compares the received calibration information with a standard calibration information table.

The present application has the following beneficial effects:
1) according to the present application, the contacts are respectively installed on the stationary base plate and the movable base plate which are oppositely arranged, and when the controller monitors that the contact state of the two contacts is abnormal (that is, when the position deviation occurs between the two contacts) through the contact detection loop, the adjusting components are used to automatically drive the two contacts to move relatively horizontally or vertically until the contacts are normal again, so that the independent real-time monitoring and automatic calibration of the door lock are realized, and the door lock can be locked smoothly when the landing door and the car door are closed, thereby reducing the delay caused by inaccurate door operation and increasing the cost of manual maintenance and adjustment;
2) by adding a base plate motor to drive the movable base plate to rotate relative to the stationary base plate, the range of relative adjustment of the two contacts can be further widened to ensure smooth alignment of the two contacts;
3) by mounting a counterweight on the movable base plate and adopting the adjusting components, the counterweight can move horizontally or vertically on the movable base plate, so that the center of gravity of the movable base plate can be maintained at the required position by the position adjustment of the counterweight with the cooperation with the movable contacts installed on the movable base plate; and
4) by the adjusting parts (including an adjusting motor, a driving roller and a driven roller) and positioning parts composed of a pair of grippers (including a base shell, a push plate, a push rod, a piston, a spring, an electromagnet and a permanent magnet) to form a strip movability mechanism, not only can the rotation of driving roller and driven roller be used to give friction driving force to the upper and lower sides of the sliding strip vertically, but also the grippers respectively arranged on the left and right sides of the sliding strip jointly loosen or clamp the sliding strip under the dual action of magnetic force and elastic force, and the overall structure is exquisite, which can reduce the volume of the device.

The features and advantages of the present application will be described in detail by examples with the accompanying drawings.

### BRIEF DESCRIPTION OF DRAWINGS

FIG. 1 is a front view of a self-calibration elevator door lock contact making device of the present application;

FIG. 2 is a schematic diagram of the three-dimensional structure of the self-calibration elevator door lock contact making device of the present application when removing the block movability mechanism and the base plate motor.

FIG. 3 is an assembly schematic diagram of the sliding block, sliding strip and strip movability mechanism of the self-calibration elevator door lock contact making device of the present application;

FIG. 4 is an enlarged schematic view at A of FIG. 3;

FIG. 5 is a front view of the block movability mechanism of the self-calibration elevator door lock contact making device of the present application.

In the figures: 1—Stationary base plate, 11—Stationary chute, 2—Movable base plate, 21—Movable chute, 3—Sliding block, 4—Sliding block, 5—Contact, 6—Strip movability mechanism, 61—Adjusting part, 611—Adjusting motor, 612—Driving roller, 613—Driven roller, 62—Positioning component, 621—Base shell, 622—Push plate, 623—Push rod, 624—Piston, 625—Spring, 626—Electromagnet, 627—Permanent magnet, 7—Block movability mechanism, 71—Movability motor, 72—Screw rod, 73—Sliding seat, 74, 8—Base plate motor, 9—Counterweight.

### DESCRIPTION OF EMBODIMENTS

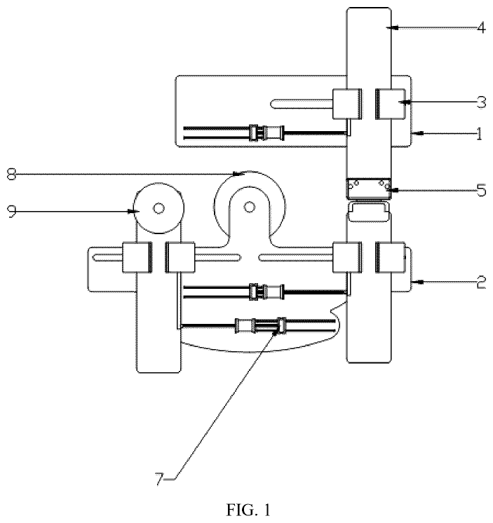

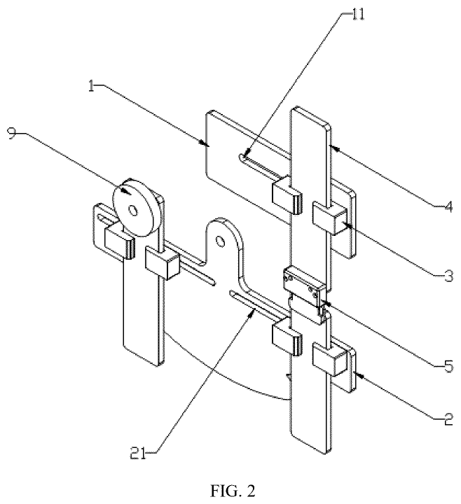

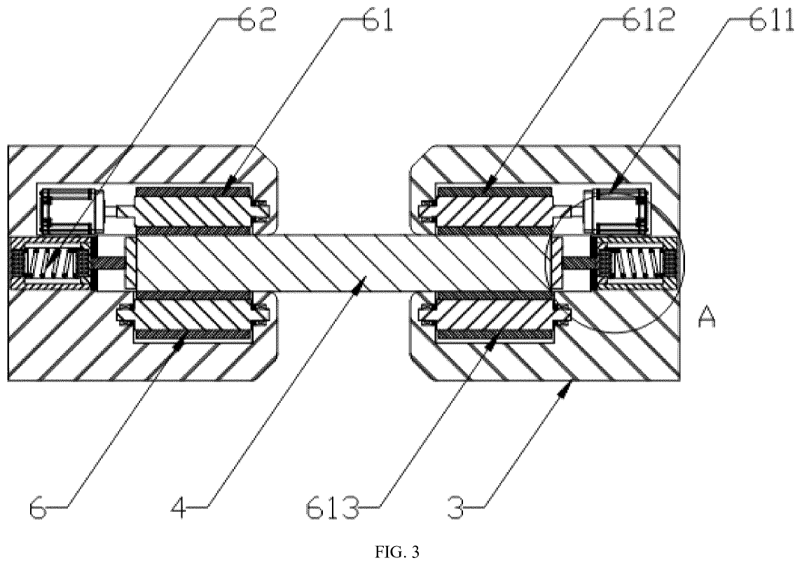

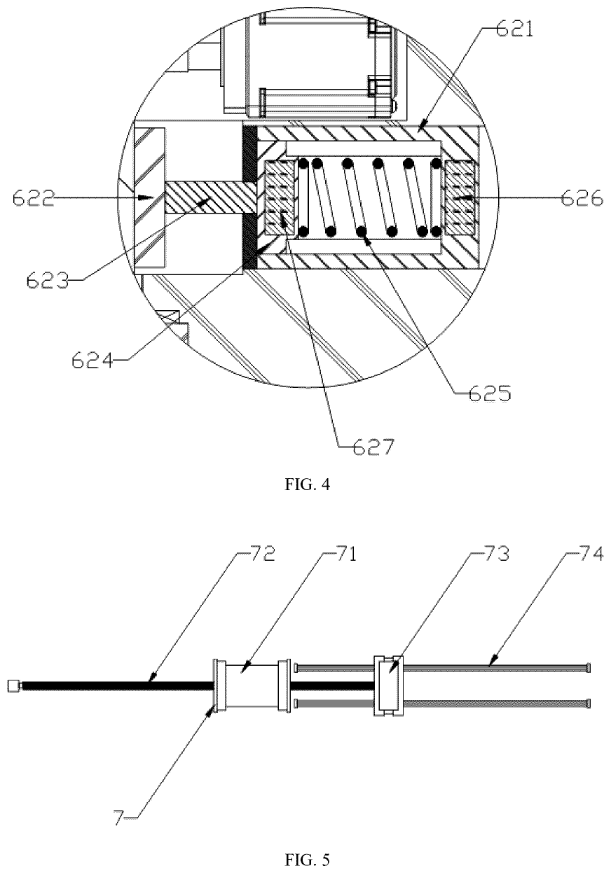

Refer to FIG. 1 to FIG. 5, that self-calibration elevator door lock contact making device of the present application includes a stationary base plate 1, a movable base plate 2, contacts 5, adjusting components and a controller, wherein the stationary base plate 1 and the movable base plate 2 are oppositely arrange and are respectively provided with the contacts 5, and the two contacts 5 can be relatively moved laterally or longitudinally through the adjusting components respectively; and the controller is electrically connected with two groups of adjusting components and provided with a contact detection loop (i. e., a contact detection system used for detecting the position and state of the contact 5 and providing real-time elevator door lock contact information, including any deviation or abnormality.)

It further includes a base plate motor 8, and the movable base plate 2 is driven by the base plate motor 8 to rotate relative to the stationary base plate 1.

A counterweight 9 is also mounted on the movable base plate 2, and the counterweight 9 and the contacts 5 located on the movable base plate 2 are respectively arranged on opposite sides of the movable base plate 2; the counterweight 9 can move laterally or vertically on the movable base plate 2 through the adjusting component.

The adjusting component includes a sliding block 3, a sliding strip 4, a strip movability mechanism 6 and a block movability mechanism 7, wherein the counterweight 9 and two contacts 5 are respectively installed on the three sliding strips 4, and the three sliding strips 4 are respectively connected in a sliding manner to the three sliding blocks 3, wherein one of the sliding blocks 3 is connected in a sliding manner to a stationary chute 11 of the stationary base plate 1, and the counterweight 9 and the other sliding block 3 are respectively connected in a sliding manner to the two movable chutes 21 located on the movable base plate 2; the three sliding blocks 3 respectively drive the corresponding sliding blocks 4 to slide vertically through the strip movability mechanism 6; the stationary base plate 1 drives one sliding block 3 to slide horizontally along the stationary chute 11 through the block movability mechanism 7, and the movable base plate 2 drives the remaining two sliding blocks 3 to slide horizontally along the movable chute 21 through the block movability mechanism 7.

The strip movability mechanism 6 includes an adjusting part 61 and a positioning part 62, wherein the adjusting part 61 includes an adjusting motor 611, a driving roller 612 and a driven roller 613; the driving roller 612 and the driven roller 613 are rotatably connected in the sliding block 3, respectively, and the axial surfaces can contact the upper surface and the lower surface of the sliding block 4; one end of the driving roller 612 is connected with the output shaft of the adjusting motor 611; the positioning part 62 consists of grippers respectively arranged on the left and right sides of the sliding block 4, and the gripper includes a base shell 621, a push plate 622, a push rod 623, a piston 624, a spring 625, an electromagnet 626 and a permanent magnet 627, wherein one end of the push rod 623 is provided with the push plate 622 and the other end of the push rod 623 is connected with the piston 624 after extending into the base shell 621; two ends of the spring 625 are respectively connected with the base shell 621 and the piston 624, and the electromagnet 626 and the permanent magnet 627 are respectively installed in the base shell 621 and the piston 624, and the push plate 622 is arranged towards the left or right side of the sliding block 4.

The block movability mechanism 7 includes a movability motor 71, a screw nut, a screw rod 72, a sliding seat 73 and a sliding rail 74, wherein the movability motor 71 and the sliding rail 74 are both fixed on the stationary base plate 1 or the movable base plate 2; the screw nut is rotatably connected in the movability motor 71; the screw rod 72 penetrates through the movability motor 71 and is in threaded connection with the screw nut; the sliding seat 73 is connected with the screw rod 72 and is slidably connected on the sliding rail 74 at the same time; the screw rod 72 or the sliding seat 73 is connected with the corresponding sliding block 3.

The controller is also provided with a short-connection/bridge-connection command transmitter which can send the short-connection/bridge-connection command of the door lock and a short-connection/bridge-connection circuit for realizing the short-connection/bridge-connection of the door lock.

The controller is also provided with a calibration information receiver which can receive the calibration information of two contacts 5 in real time and a judgment logic module which compares the received calibration information with a standard calibration information table. The calibration information receiver can collect data generated in the calibration process for subsequent judgment of the accuracy of calibration results; the standard calibration information table stores the standard calibration information obtained in advance, so as to serve as a comparison reference for later judging whether the two contacts 5 are normal or not; based on the contact detection information and feedback information, the judgment logic module can realize the accurate calibration of two contacts 5 by an automatic adjustment algorithm, thus improving the efficiency and accuracy of calibration.

In addition, the controller can be equipped with a feedback control system, so as to monitor the feedback information during the calibration process (including the adjustment of elevator door lock contacts and any abnormality) and provide real-time feedback for the maintenance personnel, so that the maintenance personnel can manually adjust the instructions of the calibration controller, ensure the smooth calibration process and improve the stability and reliability of the device.

The work process of that application includes the following steps:

During the working process, the controller can monitor the contact state of two contacts 5 in real time through the contact detection loop. When the contact detection loop detects that the two contacts 5 are not normally butted, the controller sends a door lock short-connection/bridge-connection command through the short-connection/bridge-connection command transmitter on the one hand, thus triggering the corresponding adjustment operation by using the short-connection/bridge-connection loop, and sends a calibration command through the calibration command transmitter on the other hand to enter a calibration mode.

During the adjustment process, the base plate motor 8 can drive the movable base plate 2 to rotate, so that the contacts 5 mounted on the movable base plate 2 rotate relative to the contacts 5 mounted on the stationary base plate 1. In addition, as for the adjusting component, the three strip movability mechanisms 6 can respectively drive the corresponding sliding strips to move vertically, and the three block movability mechanisms 7 can respectively drive the corresponding sliding blocks 3 to move laterally, so that on the one hand, the horizontal position and height position of the two contacts 5 can be adjusted, and on the other hand, the movable base plate 2 can be better balanced by adjusting the horizontal position and height position of the counterweight 9. Specifically, when the strip movability mechanism 6 needs to drive the sliding block 4 to move vertically, the electromagnet 626 is energized to attract the permanent magnet 627, so that the piston 624 drives the push plate 622 away from the sliding block 4 and compresses the spring 625 synchronously, and then the adjusting motor 611 is started to drive the driving roller 612 to rotate, so that the driving roller 612 and the driven roller 613 can move vertically through friction during rotation. When the sliding block 4 moves vertically in place, the adjusting motor 611 stops driving, and at the same time, the electromagnet 626 is de-energized, so that the push plate 622 is pushed close to the sliding block 4 by the elastic force of the spring 625 to keep the sliding block 4 in place. In addition, electromagnets 626 and permanent magnets 627 with repulsive magnetic forces can also be used to improve the pushing force of the push plate 622 on the sliding block 4. For the block movability mechanism 7, the movability motor 71 can drive the screw rod 72 and the sliding seat 73 to move left and right by driving the screw nut to rotate forward and backward, so as to realize the lateral movement of the sliding strip 4.

During calibration, the calibration information receiver located in the controller can receive the calibration information of the two contacts 5 in real time, and the judgment logic module can compare the pre-acquired standard calibration information (standard calibration information table) with the actual calibration information, so as to judge whether the two contacts 5 are normal and output corresponding results.

The above embodiment is an illustration of the present application, not a limitation of the present application, and any solution after simple transformation of the present application belongs to the protection scope of the present application.

1. A self-calibration elevator door lock contact making device, comprising a stationary base plate (1), a movable base plate (2), contacts (5), adjusting components and a controller, wherein the stationary base plate (1) and the movable base plate (2) are oppositely arranged and are respectively provided with the contacts (5), and the two contacts (5) are capable of moving relatively laterally or longitudinally through the adjusting components respectively; the controller is electrically connected with two groups of adjusting components and provided with a contact detection loop capable of monitoring a contact state of the two contacts (5).

2. The self-calibration elevator door lock contact making device according to claim 1, further comprising a base plate motor (8), and the movable base plate (2) is driven by the base plate motor (8) to rotate relative to the stationary base plate (1).

3. The self-calibration elevator door lock contact making device according to claim 2, wherein a counterweight (9) is also installed on the movable base plate (2); the counterweight (9) and the contact (5) located on the movable base plate (2) are respectively arranged on opposite sides of the movable base plate (2), and the counterweight (9) is capable of moving transversely or longitudinally on the movable base plate (2) through the adjusting components.

4. The self-calibration elevator door lock contact making device according to claim 3, wherein the adjusting component comprises a sliding block (3), a sliding strip (4), a strip movability mechanism (6) and a block movability mechanism (7); the counterweight (9) and the two contacts (5) are respectively installed on three sliding strips (4), and the three sliding strips (4) are respectively connected with the three sliding blocks (3) in a sliding manner, wherein one of the sliding blocks (3) is connected to a stationary chute (11) of the stationary base plate (1) in a sliding manner; the counterweight (9) and the other sliding block (3) are respectively connected to two movable chutes (21) located on the movable base plate (2) in a sliding manner; the three sliding blocks (3) respectively drive the corresponding sliding strips (4) to vertically slide through the strip movability mechanism (6); the stationary base plate (1) drives one of the sliding blocks (3) to slide horizontally along the stationary chute (11) through the block movability mechanism (7), and the movable base plate (2) drives the remaining two sliding blocks (3) to slide horizontally along the movable chute (21) through the block movability mechanism (7) respectively.

5. The self-calibration elevator door lock contact making device according to claim 4, wherein the strip movability mechanism (6) comprises an adjusting part (61) and a positioning part (62), and the adjusting part (61) comprises an adjusting motor (611), a driving roller (612) and a driven roller (613); the driving roller (612) and the driven roller (613) are rotatably connected in the sliding blocks (3) respectively, and the axial surfaces thereof can contact with the upper surface and the lower surface of the sliding block (4); one end of the driving roller (612) is connected with an output shaft of the adjusting motor (611); the positioning part (62) is composed of grippers respectively arranged on the left and right sides of the sliding strip (4); the gripper comprises a base shell (621), a push plate (622), a push rod (623), a piston (624), a spring (625), an electromagnet (626) and a permanent magnet (627), wherein one end of the push rod (623) is provided with the push plate (622), and the other end of the push rod (623) is connected with the piston (624) after extending into the base shell (621); two ends of the spring (625) are respectively connected with the base shell (621) and the piston (624), the electromagnet (626) and the permanent magnet (627) are respectively installed in the base shell (621) and the piston (624), and the push plate (622) is arranged towards the left or right side of the sliding block (4).

6. The self-calibration elevator door lock contact making device according to claim 4, wherein the block movability mechanism (7) comprises a movability motor (71), a screw nut, a screw rod (72), a sliding seat (73) and a sliding rail (74); both the movability motor (71) and the sliding rail (74) are fixed on the stationary base plate (1) or the movable base plate (2); the screw nut is rotatably connected in the movability motor (71), the lead screw (72) penetrates through the movability motor (71) and is in threaded connection with the screw nut; the sliding seat (73) is connected with the lead screw (72) and is simultaneously connected with the sliding rail (74) in a sliding manner; and the lead screw (72) or the sliding seat (73) is connected with the corresponding slide block (3).

7. The self-calibration elevator door lock contact making device according to claim 1, wherein the controller is further provided with a short-connection/bridge-connection command transmitter which can send a door lock short-connection/bridge-connection command and a short-connection/bridge-connection circuit for realizing the door lock short-connection/bridge-connection.

8. The self-calibration elevator door lock contact making device according to claim 2, wherein the controller is further provided with a short-connection/bridge-connection command transmitter which can send a door lock short-connection/bridge-connection command a and short-connection/bridge-connection circuit for realizing the door lock short-connection/bridge-connection.

9. The self-calibration elevator door lock contact making device according to claim 3, wherein the controller is further provided with a short-connection/bridge-connection command transmitter which can send a door lock short-connection/bridge-connection command and a short-connection/bridge-connection circuit for realizing the door lock short-connection/bridge-connection.

10. The self-calibration elevator door lock contact making device according to claim 4, wherein the controller is further provided with a short-connection/bridge-connection command transmitter which can send a door lock short-connection/bridge-connection command and a short-connection/bridge-connection circuit for realizing the door lock short-connection/bridge-connection.

11. The self-calibration elevator door lock contact making device according to claim 5, wherein the controller is further provided with a short-connection/bridge-connection command transmitter which can send a door lock short-connection/bridge-connection command and a short-connection/bridge-connection circuit for realizing the door lock short-connection/bridge-connection.

12. The self-calibration elevator door lock contact making device according to claim 6, wherein the controller is further provided with a short-connection/bridge-connection command transmitter which can send a door lock short-connection/bridge-connection command and a short-connection/bridge-connection circuit for realizing the door lock short-connection/bridge-connection.

13. The self-calibration elevator door lock contact making device according to claim 1, wherein the controller is further provided with a calibration information receiver which can receive the calibration information of the two contacts (5) in real time and a judgment logic module which compares the received calibration information with a standard calibration information table.

14. The self-calibration elevator door lock contact making device according to claim 2, wherein the controller is further provided with a calibration information receiver which can receive the calibration information of the two contacts (5) in real time and a judgment logic module which compares the received calibration information with a standard calibration information table.

15. The self-calibration elevator door lock contact making device according to claim 3, wherein the controller is further provided with a calibration information receiver which can receive the calibration information of the two contacts (5) in real time and a judgment logic module which compares the received calibration information with a standard calibration information table.

16. The self-calibration elevator door lock contact making device according to claim 4, wherein the controller is further provided with a calibration information receiver which can receive the calibration information of the two contacts (5) in real time and a judgment logic module which compares the received calibration information with a standard calibration information table.

17. The self-calibration elevator door lock contact making device according to claim 5, wherein the controller is further provided with a calibration information receiver which can receive the calibration information of the two contacts (5) in real time and a judgment logic module which compares the received calibration information with a standard calibration information table.

18. The self-calibration elevator door lock contact making device according to claim 6, wherein the controller is further provided with a calibration information receiver which can receive the calibration information of the two contacts (5) in real time and a judgment logic module which compares the received calibration information with a standard calibration information table.
